(19) United States
(12) Patent Application Publication
(10) Pub. No.: US 2014/0102580 A1
(43) Pub. Date: Apr. 17, 2014

(54) METHOD AND APPARATUS FOR A FROZEN CONFECTION PRODUCT

(71) Applicant: Wells Enterprises, Inc., Le Mars, IA (US)

(72) Inventors: Dale R. Kass, Le Mars, IA (US); Michael E. Bilunas, Sioux City, IA (US)

(73) Assignee: Wells Enterprises, Inc., Le Mars, IA (US)

(21) Appl. No.: 13/653,777

(22) Filed: Oct. 17, 2012

(51) Int. Cl. A23G 9/28; B65B 3/04

(52) U.S. Cl. 141/9; 141/1; 222/478

(57) ABSTRACT

A method and apparatus for making a frozen confection product is provided. The method includes the use of a plurality of nozzles on a product-making machine. The nozzles are rotated while dispensing a frozen confection to create a swirl configuration in a product holder, such as a cone. The nozzles continue to rotate and dispense the frozen confection therefrom while moving from one set of product holders to the next, to continually dispense the frozen confection to fill each additional set of product holders. An additional confection may also be dispensed in the interior and exterior of the frozen confection and/or product holder. Additional stations, such as filling, stomping, freezing, dipping, and wrapping may be also included with the machine, with the product being indexed to the additional stations of the machine.

### FIELD OF THE INVENTION

The present invention relates generally to a process and apparatus for making a frozen confection product. More particularly, but not exclusively, the invention relates to a process an apparatus for making a mini swirl frozen confection by continuously rotating a nozzle while dispensing the frozen confection into a product holder.

### BACKGROUND OF THE INVENTION

Frozen confections, such as ice cream cones, have at times been dispensed in a swirl configuration, known generally as a swirl cone. Generally, the swirl cones have been made using soft serve ice cream machines, as the softer frozen confection is able to be dispensed in the shape and speed needed to create the swirl in the cone, or other product holder, such as a cup, glass, or the like. The soft serve swirl cones are made by an individual, either a customer or a worker, who activates the dispensing of the soft serve confection through a rotating nozzle and into the product holder. The machine is then stopped, which stops the dispensing of the soft serve confection.

Soft serve confections are generally prone to melting faster than other types of frozen confections, such as that purchased in the freezer section of a store. Therefore, to avoid the soft serve swirl cone from melting and making a mess, it must be eaten quickly. Eating the cone quickly can take the enjoyment out of the experience, and can even cause the condition generally referred to as “ice cream headaches.” Furthermore, many of the swirl cones come in one size, which can be more than one consumer is wanting at a time. As the swirl cones are generally licked, they are not an item that people feel comfortable sharing with one another. Instead of enjoying the entire cone, the consumer may instead eat what they want, while disposing of the rest.

Furthermore, many existing frozen confection product making machines are not equipped with the proper components to make a smaller than average swirl cone. The nozzles of the components are sized or spaced from one another such that it would be an impossibility to adjust the machines to dispense different amounts of frozen confections to be able to make different sizes of cones. In addition, due to the costs and space required for the product making machines, it may not be worth the expense or space to obtain different frozen confection dispensing machines capable of dispensing varying amounts of frozen confection.

Therefore, there is a need in the art for a method and apparatus for making a frozen confection product that can be shaped similar to a swirl cone, that uses frozen confection instead of soft serve, and that can be incorporated into existing machines used to make frozen confection products.

### SUMMARY OF THE INVENTION

It is therefore a principal object, feature, and/or advantage of the present invention to provide a method and/or apparatus that overcomes the deficiencies in the art.

It is another object, feature, and/or advantage of the present invention to provide a method and apparatus for making a frozen confection product.

It is yet another object, feature, and/or advantage of the present invention to provide a method and apparatus for making a swirl cone- type product using a frozen confection instead of soft serve.

It is still another object, feature, and/or advantage of the present invention to provide a method and apparatus for making a mini-type swirl cone product from a frozen confection.

It is a further object, feature, and/or advantage of the present invention to provide an improved method and apparatus for making a frozen confection product that can use at least some existing confection equipment.

It is still a further object, feature, and/or advantage of the present invention to provide a method and apparatus for creating a mini swirl-type frozen confection product that can be adjusted to incorporate different flavors and toppings.

It is still a further object, feature, and/or advantage of the present invention to provide a method and apparatus for creating a mini swirl-type frozen confection product that can be adjusted to incorporate second confections within the frozen confection.

These and/or other objects, features, and advantages of the present invention will be apparent to those skilled in the art. The present invention is not to be limited to or by these objects, features and advantages. No single embodiment need provide each and every object, feature, or advantage.

According to an aspect of the present invention, a method of making a frozen confection product is provided. The method includes providing a plurality of frozen confection dispensing nozzles; rotating the plurality of nozzles; dispensing a frozen confection from the nozzles into a first plurality of product holders as the nozzles rotate; and moving the nozzles to a second plurality of product holders to dispense a frozen confection therein; wherein the plurality of nozzles continuously rotate and dispense the frozen confection during the step of moving from the first plurality of products holders to the second plurality of product holders.

According to another aspect of the present invention, a method of making a frozen confection product is provided. The method includes providing a plurality of dispensing nozzles and a plurality of product holders; rotating the dispensing nozzles while dispensing a frozen confection into a first set of the plurality of product holders; moving the product holders relative to the dispensing nozzles to dispense the frozen confection into a second set of the plurality of product holders; wherein the dispensing nozzles continuously rotate and dispense the frozen confection as the product holders are moved from the first set to the second set.

According to yet another aspect of the present invention, an apparatus for making a frozen confection product is provided. The apparatus includes a tubular nozzle comprising a fixed insertion end for receiving a frozen confection a rotatable dispensing end for dispensing the frozen confection; a first gear at the dispensing end and fixed thereto; and a second gear operably connected to the first gear and adapted to continuously rotate the first gear and dispensing end of the nozzle while the nozzle dispenses a frozen confection.

### BRIEF DESCRIPTION OF THE DRAWINGS

FIG. 1A is an elevation view of a frozen confection product of the sort according to the method and apparatus of the present invention.

FIG. 1B is a sectional view of the frozen confection product of FIG. 1A.

FIG. 2 is perspective partially exploded view of a frozen confection product-making machine for making a frozen confection product, such as that shown in FIGS. 1A and 1B.

FIG. 3A is an exploded view of a product filler head assembly for use with the machine of FIG. 2.

FIG. 3B is an enlarged view of a portion of the product filler head assembly of FIG. 3A.

FIG. 4 is an exploded view of an embodiment of a nozzle assembly.

FIG. 5A is an end view of a product-making machine according to the present invention.

FIG. 5B is an enlarged and partial sectional view showing a portion of the machine of FIG. 5A dispensing a frozen confection into a product holder.

FIG. 6 is a side view of a product-making machine showing the process of making a plurality of products using the machine and nozzle according to an embodiment of the present invention.

### DETAILED DESCRIPTION OF THE PREFERRED EMBODIMENTS

Before any independent features and embodiments of the invention are explained in detail, it is to be understood that the invention is not limited in its application to the details of the construction and the arrangement of the components set forth in the following description or illustrated in the drawings. The invention is capable of other embodiments and of being practiced or of being carried out in various ways. In addition, it is understood that the phraseology and terminology used herein is for the purpose of description and should not be regarded as limiting.

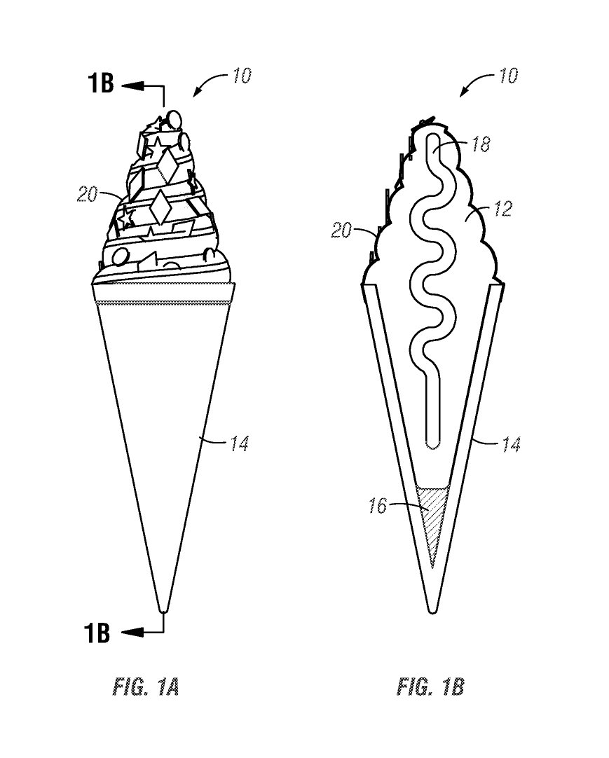

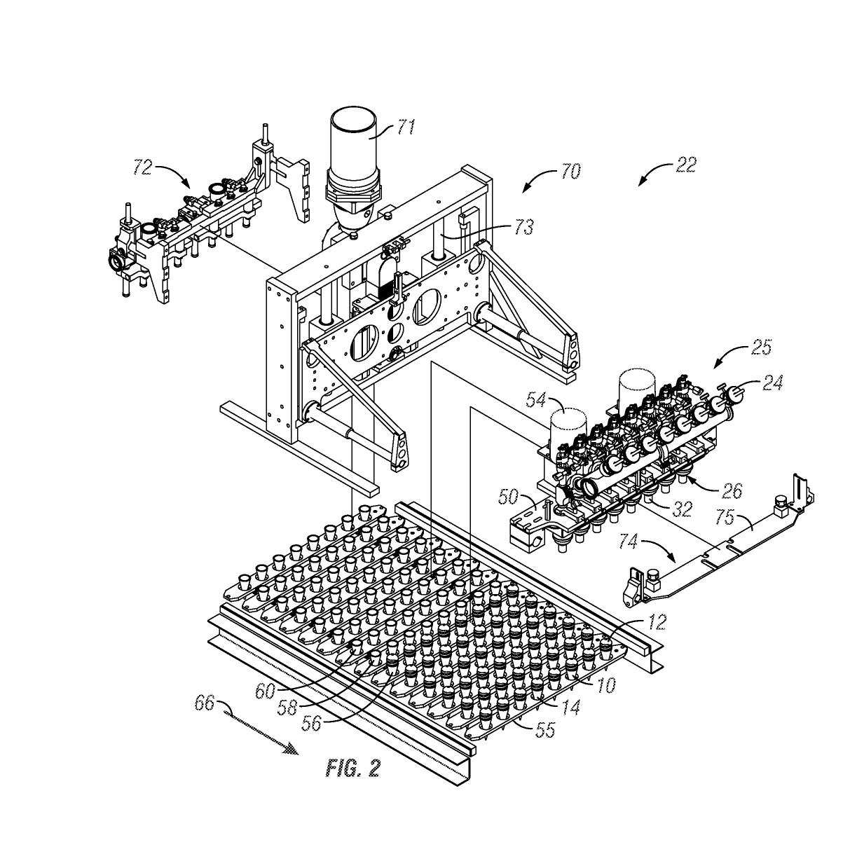

FIG. 1A is a side elevation view of a frozen confection product 10 of the sort according to the method and apparatus of the present invention. The frozen confection product 10 shown in FIG. 1A is a mini swirl cone product. The mini swirl cone 10 comprises a frozen confection 12, such as ice cream, inserted into a product holder 14, in this case being a cone. The product holder 14 may be a waffle cone, sugar cone, flavored cone, or the like. The size of the product holder 14 is not to be limiting to the present invention, as the present invention contemplates that the frozen confection product 10 includes a holder of generally all shapes and sizes. It is also contemplated by the present invention that the product holder 14 can be an object such as a cup or bowl, and need not be edible. Furthermore, the product holder could be a stick, or even a wrapper. For example, it is contemplated that the frozen confection product 10 could be without a holder or stick, and could instead be a stand-alone product that has been frozen to hold its shape. The invention is not to be limited to the configuration of the product holder 14 shown in FIGS. 1A and 1B.

The term “mini swirl cone”, which has been used intermittently with the term frozen confection product 10, is intended to mean a frozen confection product having a configuration similar to the swirl type style of a soft serve ice cream cone. In addition, the term “mini” is not to be limiting to the present invention. While the term “mini” can be used to describe a product smaller than products that are on the market currently, it can be contemplated that the term be used to describe a frozen confection product 10 being generally within the range of 1-3 ounces. However, the present invention may include generally any sized product, and contemplates a frozen confection product 10 containing approximately 0.5-10 ounces of frozen confection. Thus, while the present invention is preferred for use in mini swirl cone type frozen confection products, it is contemplated that any size and configuration of frozen confection or frozen ice product be included as part of the present invention. Furthermore, the term frozen confection 12 may refer to any frozen confection, including but not limited to, ice cream, sherbet, gelato, custard, frozen yogurt, or the like. The invention is not to be limited to the type of frozen confection described, and contemplates that other types of frozen confection, and also non-frozen confections, may be used as included in the present invention.

FIGS. 1A and 1B also show the interior of the frozen confection product 10. Accordingly, FIG. 1B shows a filling 16 located at a lower end of the product holder 14. The filling 16 may be a chocolate filling or any other confection filling. As shown, the frozen confection 12 fills the area within the product holder 14 above the filling 16 and extends to an area above the top of the product holder 14. Furthermore, a second confection 18 may be inserted with the frozen confection 12 and can comprise a frosting or other confection. In addition, it is contemplated that a third confection 20, such as a clear coating confection, chocolate coating confection, or the like, may be placed on the outside of the frozen confection extending above the product holder 14. The present invention also contemplates that additional confections may be added to the frozen confection product 10, such as sprinkles, gummies, or the like. The exact composition of the frozen confection product 10 is not to be limited to the configuration shown in the Figures, and it is to be understood that many other variations, ingredients, or compositions may be used and still be covered by the present invention.

FIG. 2 is a configuration of a product making machine 22 capable of or adapted to make a frozen confection product 10, such as that shown and described herein. The product-making machine 22 generally comprises a product filler head assembly 25 including a plurality of nozzles 26 operatively connected to a frozen confection source (not shown) via confection tubes 24. Thus, the frozen confection 10 can be transferred from a holding area, such as a tank, vat, or other refrigerated area, and dispensed through the tubes 24 to the nozzles 26 for dispensing into a product holder 14, which can be positioned on a conveyor or other moving apparatus 55. FIG. 2 also shows a servo drive 70, a filling station 72, and a stomper 74. The servo drive 70 includes a servo motor 71 and one or more pistons or pulleys 73, which are used in connection to move one or more of the stations of the machine 22 in a generally vertical direction (both up and down). Thus, the stations 25, 72, 74, may move in tandem, or the present invention contemplates that the stations move independent one another, which would require additional motors, pistons, pulleys, etc.

The filling station 72 includes a filling nozzle 76, which may be a spray filling nozzle that is configured to dispense the filling 16 into the product holder 14 prior to filling the holder with a frozen confection 12. For example, the filling station 72 may be a chocolate filling station that sprays chocolate through the nozzle 76 into the bottom of the product holder 14. The product filler head assembly 25 is configured to dispense the frozen confection 12 into the product holders 14 via nozzles 26 as a row or otherwise configured plurality of holders 14 are indexed along the machine 22 and under the nozzles. The stomper 74 includes at least one stomping plate 75, and is configured to tap or come in contact with the top of the swirled frozen confection 12 to flatten the top of the confection. Other stations, such as a freezer station, dipping station, coating station, wrapping station, etc. are not shown in FIG. 2, but are to be understood to be included in some variations of the machine. Other stations may be included depending on the type of frozen confection product being produced. Furthermore, as will be discussed, a plurality of product holders 14 are indexed in rows 56, 58, 60 in the direction shown generally by the arrow 66 to move the holders 14 in relation to the various stations of the product-making machine 22. The holders 14 may be held in the indexer 55, which aids in moving and configuring the holders relative to the various stations of the machine 22.

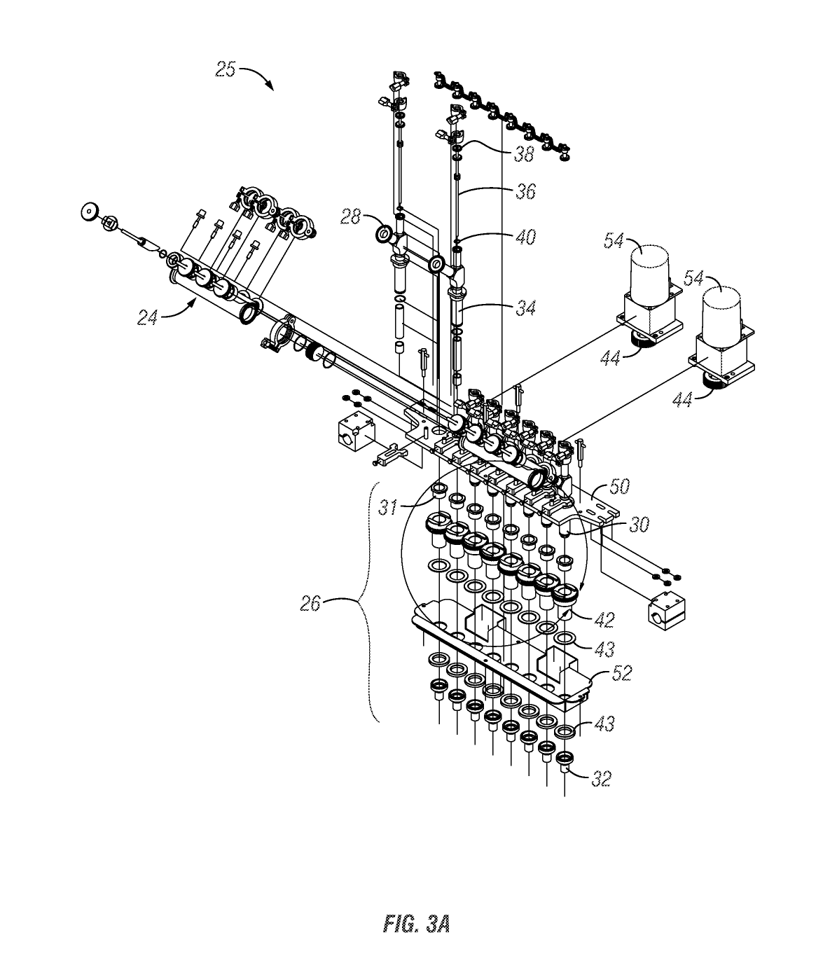

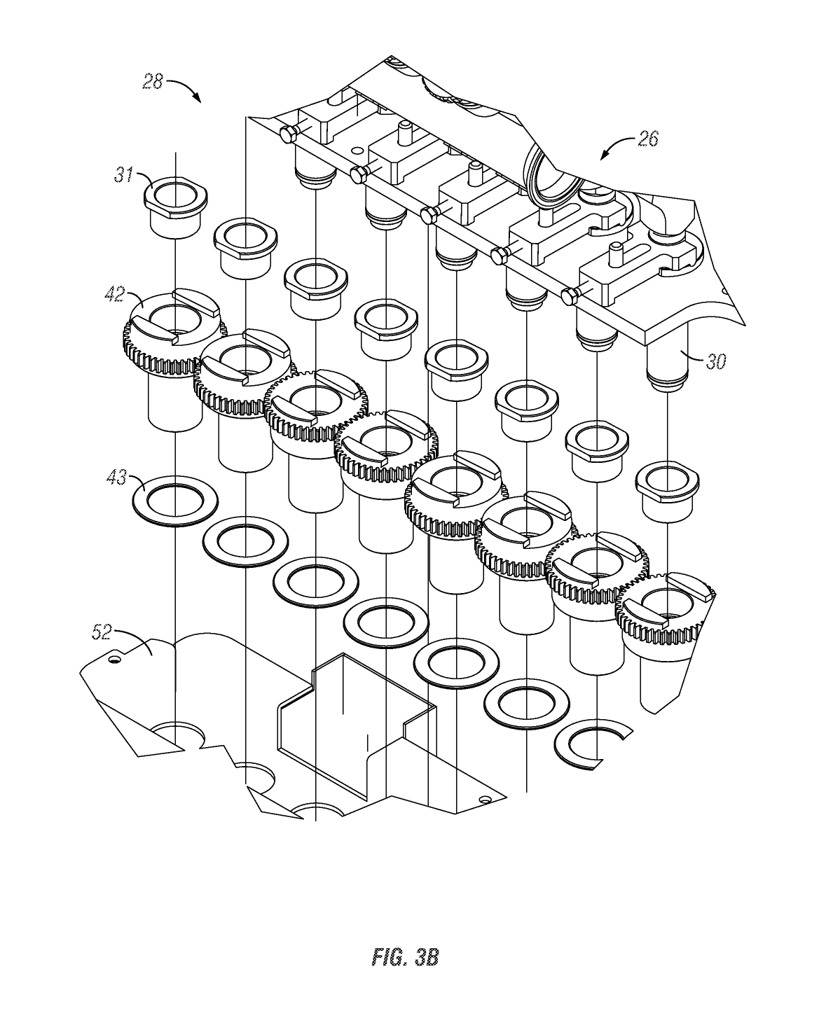

Other components of the product-making machine 22 may include motors (both electrical/electro-servo and mechanical), exhaust, pneumatics, hydraulics, and the like. The exact configuration of the product-making machine 22 may be varied according to the type of product being produced, amount of space available, as well as other factors. In addition, the number of and configuration of the nozzles 26 may also be varied according to the machine 22. For example, while FIG. 2 shows the plurality of eight nozzles 26 in a row, it is contemplated that the nozzles may be staggered or that there be multiple columns of nozzles 26. Other variations may exist in the product-making machine 22 configuration according to the type of frozen confection product 10 being made, including the size and the number thereof. FIGS. 3A and 3B are views of an embodiment of a product filler head assembly 25, which includes a plurality of nozzles 26 capable of dispensing a confection to make or produce a frozen confection product 10 such as that shown in FIG. 1A according to the present invention. It is noted that the nozzles 26 shown in FIGS. 3A and 3B may be one example of a nozzle used with the product filler head assembly 25 of the product-making machine 22 of FIG. 2. The nozzle 26 generally comprises a tube having an insertion end 28 and opposite dispensing end 30. The insertion end 28 is connected to the frozen confection source such that the frozen confection 12 enters the nozzle 26 through the insertion end 28. The confection 12 is dispensed through the nozzle 26 at the dispensing end 30. In addition, a cover 32 may be placed over the dispensing end 30 of the nozzle 26 to control the amount and direction of the frozen confection from the nozzle 26. Therefore, the cover 32 may take a variety of shapes, and include an opening having a variety of shapes and/or apertures therethrough. Furthermore, while the Figures show the tube of the nozzle 26 to be generally vertical, it is contemplated that the tube may be placed at any angle relative to vertical, to vary the product.

An inner tube 36 (also referred to as a second nozzle) may be included with and at least partially inside the outer tube 34 of the nozzle 26. The inner tube 36 is configured to receive the second confection 18 to be inserted with the frozen confection 12, as shown in FIG. 1A above. However, the inner tube 36 need not be included in all embodiments. Furthermore, the inner tube 36 may be included and not used in all methods for making the frozen confection product. The inner tube 36 includes an upper end 38 and a lower end 40. The upper end 38 is operably connected to a second confection source (not shown) and receives the second confection 18 therefrom. The lower end 40 is at least partially housed within the outer tube 34 of the nozzle 26. Thus, the lower end 40 of the inner tube 36 and the outer tube 34 of the nozzle 26 may be concentric such that the frozen confection 12 and the second confection 18 may be dispensed at generally the same angle from the nozzles. However, it is contemplated in some embodiments that the nozzles may not be concentric such that the confections are dispensed at varying angles relative to one another to create different types of product. The present invention contemplates generally any angle for both the nozzle 26 and the inner tube 36 to be included as part of the invention.

Positioned between first and second plates 50, 52 are first and second gears 42, 44. The first gear 42 at least partially surrounds the stationary inner tube 34 of the nozzle 26, and may be connected to the nozzle 26 via a transition member 31 at least partially surrounding the inner tube 34 of the nozzle. For example, the transition member 31 may include a configuration such that rotation of the gear 44 will likewise cause the gear 42 to rotate around the stationary inner tube 34. The first gear 42 is connected to the dispensing cover 32 such that rotation of the first gear 42 will cause the dispensing cover 32 to rotate at generally the same rotational speed or velocity. The second gear 44 is positioned adjacent the first gear 42 and includes a shaft 46 extending through the first plate 50. The shaft 46 is connected to a spinning source, such as a motor 54. The motor 54 may be an electric or servo motor. Therefore, the motor 54 will rotate the shaft 46, which in turn rotates the second gear 44. As shown in FIGS. 3A and 3B, the product filler head assembly 25 may include two motors 54, in which each motor 54 and corresponding gear 44 will rotate four first gears 42 and corresponding nozzles 26. In such a configuration, it is contemplated that the gears 42 are paired (two up, two down) across the row of nozzles 26 such that they are paired in sequence. Furthermore, the dispensing cover 32 may be connected to the first gears 42, and can be sealed via O-rings 43 or the like on opposite sides of the second plate 52 to prevent spillage.

The gears 42, 44 are connected to one another by their teeth such that rotation of one gear will cause rotation of the other gear. For example, as the shaft 46 rotates the second gear 44, this will cause the first gear 42 and therefore, the nozzle 26 to rotate as well. The rotation of the nozzle 26 aids in creating the swirl configuration of the frozen confection 12 for the frozen confection product 10. It is to be appreciated that the tube (and cover) of the nozzle may be the only component that rotates, or additional components of the nozzle may also rotate together.

Furthermore, all of the nozzles may be connected to one another via teeth of their first gears 42. Thus, the teeth of the first gear 42 of one nozzle can be engaged with the teeth of a first gear of an adjacent nozzle. The spinning of a gear of one nozzle will cause the adjacent gear and nozzle to spin at generally the same speed. Therefore, only one second gear 44 is initially required to rotate the plurality of nozzles for the machine 22. As the motor 54 will rotate the shaft 46 and thus, second gear 44 of one nozzle 26, the corresponding spinning of the first gear 42 of said nozzle will rotate the nozzle and cause the adjacent nozzle to spin as well. The spinning of the gear of the adjacent nozzle will create an effect of spinning each adjacent gear of each adjacent nozzle to cause all of the nozzles to spin at generally the same rotational velocity. This will aid in creating a standard configuration of frozen confection product 10 for a plurality of nozzles and product holders.

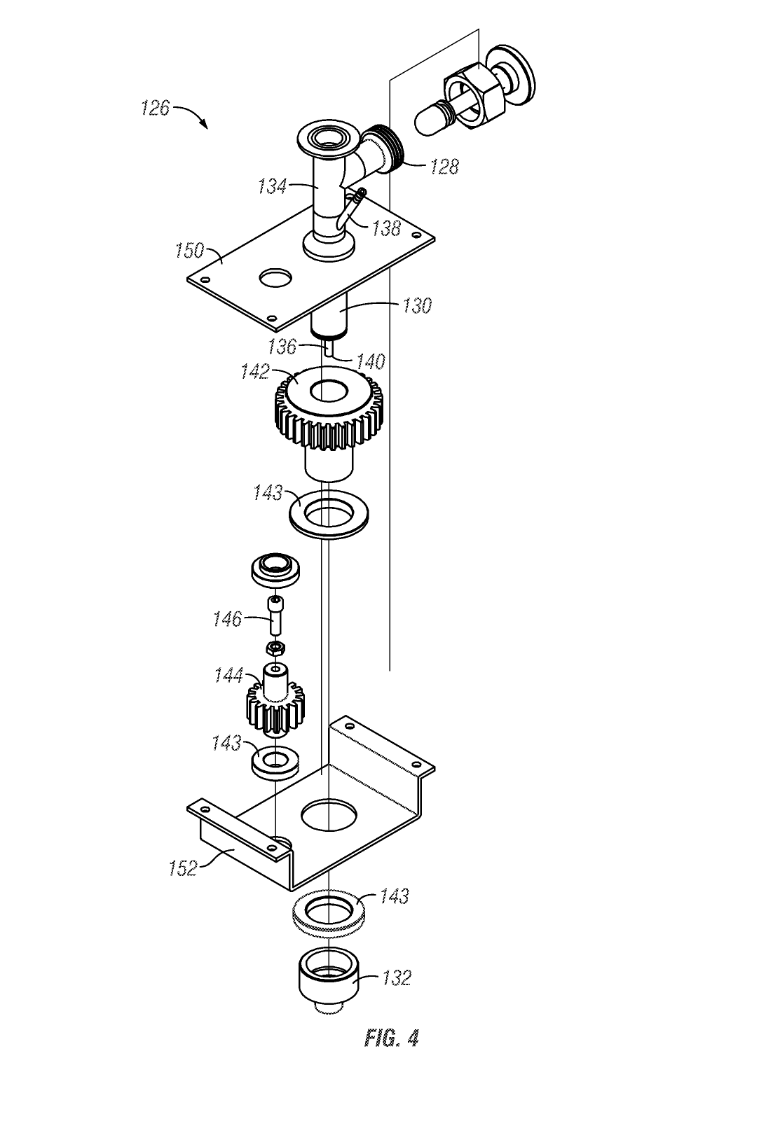

FIG. 4 shows an exploded view of another embodiment of a nozzle 126 for use with a product filler head assembly 125 according to the present invention. The nozzle 126 of FIG. 4 includes similar components to the nozzles 126 shown in FIGS. 3A and 3B, including the insertion end 128 and dispensing end 130, the outer tube 134, the inner tube 136 having and upper end 138 and lower end 140, the first gear 142 and second gear 144, the O-rings 143 (or other seals), the second gear shaft 146, and the first plate 150 and second plate 152. However, variations between the nozzles shown in the Figures will be apparent to those skilled in the art. In addition, it is contemplated that other changes may be made to the nozzles such that other configurations of nozzles may be considered part of the present invention. However, the general use and operation of the nozzle 26 and nozzle 126 will be relatively similar, with each of the nozzles capable of producing a frozen confection product 10 as described by the present invention. The nozzle 126 may be used when all of the nozzles 126 of the machine 22 are operated by a single motor 54, such that each of the nozzles are connected via the first gear 142 to rotate in sync with one another. The configuration of the nozzles 126 of FIG. 4 may also allow a separate motor 54 to be included at each nozzle 126. For example, the configuration could be used when fewer nozzles 126 are located at the product filler head assembly 125 of the machine 22, such that the nozzles 126 are not connected to one another, and are driven independently by separate motors 54 and second gears 144.

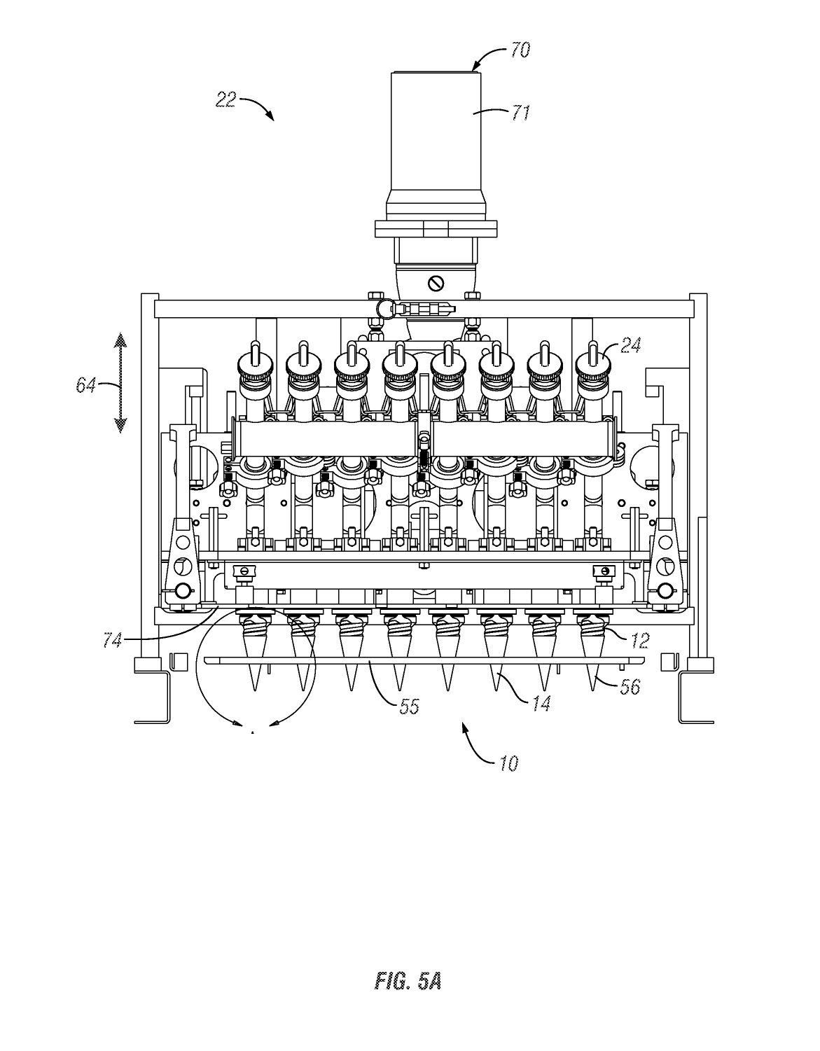

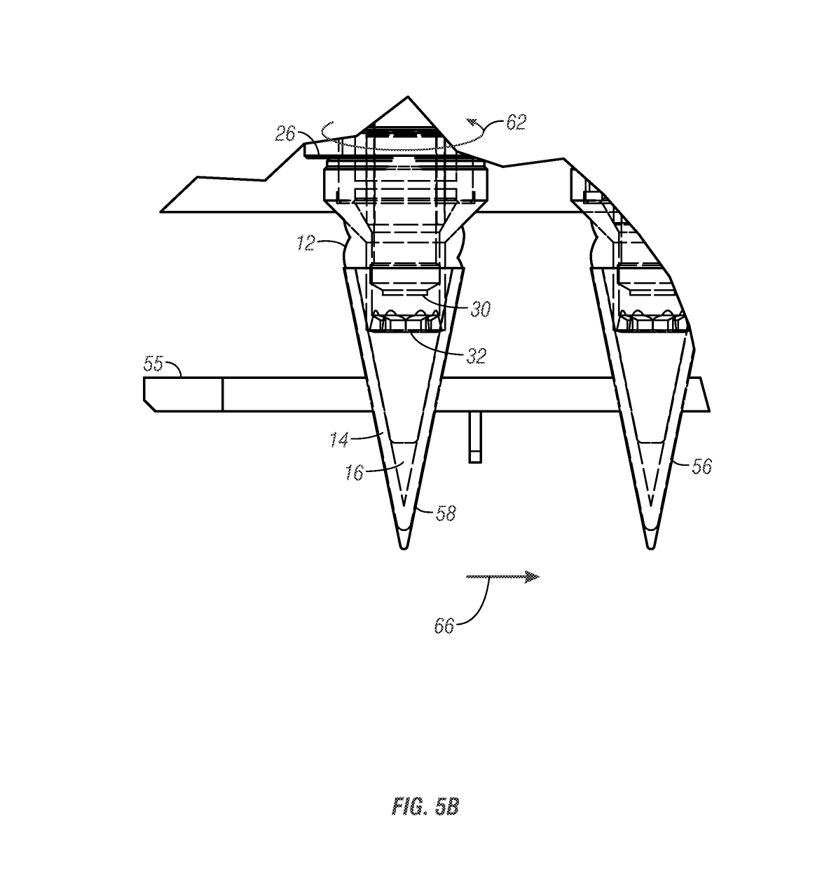

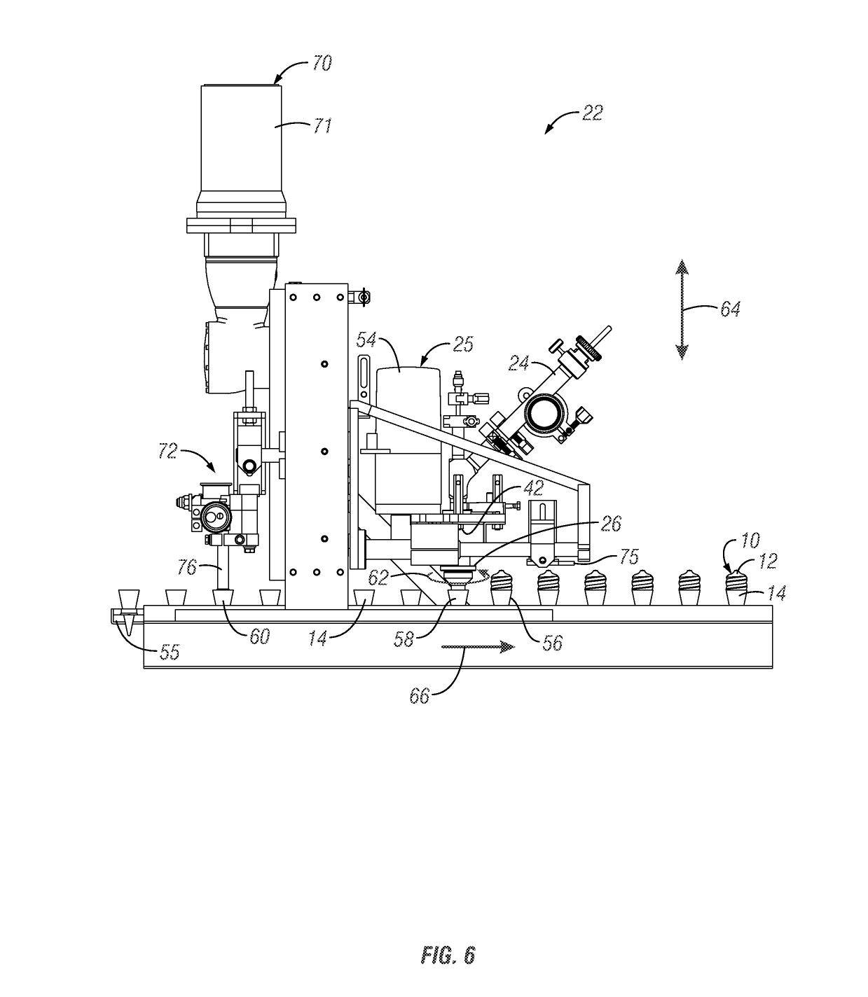

FIGS. 5A, 5B, and 6 show an exemplary embodiment of a method of making a frozen confection product 10 according to the present invention. The Figures depict a machine 22 including a plurality of nozzles 26 in a generally straight row. However, it is also to be understood that when the machine 22 includes a configuration such as staggered or multiple rows of nozzles 26, more than one nozzle 26 would be seen at a time when looking down the end row of the machine 22. Likewise, it is to be understood that multiple product holders will be in line with the product holders shown, and the invention is not limited to only filling one product holder at a time. However, in different configurations, multiple product holders will be seen being filled with a confection at a time. The present invention is not to be limited to the configuration shown and described, and contemplates various configurations in the art. Furthermore, the plurality of product holders can be positioned on a conveyor or other moving apparatus that is not shown in detail in the figures. The exact configuration of a product holder holding apparatus is not limiting to the present invention.

As discussed above, a motor 54 can be used to rotate the shaft 46 of the second gear 44. The rotation of the second gear 44 will cause like rotation of the first gear 42 for a nozzle 26 on the row of a product filler head assembly 25. The spinning of the first gear 42 for the nozzle will cause like rotation in another nozzle of the machine 22. The rotation of the first gear 42 will also cause rotation of the dispensing cover 32 of the nozzle 26. The rotation will generally be in a direction similar to that shown by the arrow 62 in FIG. 5. However, it is contemplated that the opposite rotation also be included by the present invention. As the dispensing cover 32 and other components of the nozzle 26 rotate, a frozen confection 12, such as ice cream, is dispensed through the product filler head assembly 25 of the machine 22 and into the insertion end 28 of the nozzle 26. This is shown in the enlarged view of FIG. 5B. As shown, the dispensing end 30 and/or cover 32 actually extends into the product holder 14 while dispensing the frozen confection 12.

Each nozzle 26 of the machine can be independently regulated to control the amount of and flow rate of the frozen confection 12 passed therethrough. Thus, a restrictor valve or other control valve, damper, or the like can be added to the insertion end 28 of the nozzle to control the amount of frozen confection flowing through the nozzle. The independent regulation of the nozzles accounts for the variable flow of the frozen confection through the machine 22, and aids in maintaining the proper amount of frozen confection in the tube of the nozzle 12. The location of the flow regulator for each of the nozzles can be varied as well, according to the specific machine, type of frozen confection, size of product being made, etc.

The confection is passed through the nozzle and exits at the dispensing end 30 of the nozzle 26. As discussed, the confection may also pass through a cover 32 for the dispensing end 30 of the nozzle tube 34. The rotation of the nozzle will, while dispensing the frozen confection 12, create a swirl type effect or configuration for the frozen confection 12 in the product holder 14, as is shown throughout the Figures. In addition, the nozzle 26 may move in a generally vertical direction, as shown by the arrow 64 in the Figures. The movement in the vertical direction relative to the product holder 14 will cause the frozen confection to be swirled and form a peak towards the top of the product 10. This will create the configuration shown in the Figures. The present invention also contemplates that the nozzle 26 be fixed in place to rotate in a single location, while the plurality of cones are moved in a vertical and horizontal direction to create the swirl effect on the row of cones or product holders. Therefore, the present invention is not to be limited to that shown and described.

FIG. 6 shows the nozzle 26 dispensing the frozen confection 12 into a second set 58 of product holders 14. A first set 56 of holders 14 has already been filled with the frozen confection 12, and is indexed or moved towards the stomper 74. As described, the dispenser will rotate while dispensing the frozen confection 12 to create the swirl configuration. Once the first set 56 of product holders 14 has been filled with the frozen confection 12, the product holders and/or nozzle is moved to a second set 58 of product holders to fill with frozen confection 12. Thus, the product holders 14 may move (be indexed) in the direction of the arrow 66 shown in the Figures, and/or the nozzle 26 may move in the direction shown by the arrows 64, 68. The invention contemplates that only one of the two moves or that both the nozzle and the product holders move at the same time. However, it is preferred that the nozzles 26 move only in a generally vertical direction, while the product holders 14 are indexed in a generally horizontal direction. The vertical movement of the nozzle, and particularly the speed of ascension thereof, will cut the flow of frozen confection 12 for a particular holder 14. The speed of vertical movement can be altered by programming the motors (servo drive motor 71) that move the nozzles and/or other stations. Thus, one or more programmable electro-servo motors 71 can be used to control the movement of the nozzles and other stations. The product holders 14 can be moved by a conveyor or indexing system 55. The conveyor system 55 can have an apparatus for holding the product holders in place while moving the holders, and to stop at each of the stations.

Furthermore, it is to be understood that when a second confection 18 is added through the inner tube 36 of the nozzle 26, the inner tube will dispense the confection at the same time that the outer tube 34 dispenses the frozen confection 12. The third confection 20 and/or other toppings can then be added at another station after the frozen confection 12 and second confection 18 have been added. Thus, the third confection 20 and/or other toppings can be added by the machine 22 at a different location, or can be added by a separate machine (not shown). For example, the filled products 10 can be frozen, rotated approximately 180° about a generally horizontal axis, and then dipped into the third confection 20 and/or other toppings. Furthermore, it is to be understood that the filling 16 has already been added in the product holders 14 prior to the dispensing of frozen confection 12 at the filling station 72, such as by a filling sprayer or dispenser 76. The filling 16 will generally be added in the indexed position prior to filling the product holder 14 with the frozen confection. Therefore, a spray or dispenser 76 adds the filling 16 to the product holder 14, and then the product holder 14 is indexed in position to be filled with the frozen confection.

Next, another aspect of the machine 22 can stomp the top of the frozen confection 12 in the holder 14 to flatten the top of the confection. It is contemplated that the three steps, adding the filling 16, dispensing the frozen confection 12, and stomping the frozen confection 12, can all be performed in sync (i.e., all included in the machine and moving up and down at the same time) such that the steps will be performed in three indexes of the product holders 14. It is also contemplated, as shown in FIG. 6, that the Nth set 60 of holders 14 be filled such that there are additional rows of holders 14 between the row 60 being filled with the filler 16 and the row 58 being filled with the frozen confection 12.

After the second set 58 of product holders 14 has been filled with the confection 12, the nozzle 26 and next row of holders 14 are aligned to fill the said next row of product holders 14 with the frozen confection 12. However, an aspect of the present invention includes that the nozzle continues to rotate and dispense the frozen confection 12 at all times of operation. Thus, each of the rows 56, 58, 60 of the product holders 14 may be placed closely relative to one another such that no frozen confection 12 is spilled during movement of the nozzle 26 and/or product holders 14. As shown in FIG. 6, the second set 58 of product holders 14 can quickly be filled after the first set 56 of product holders 14 have been filled. The continuous rotation and dispensing of the nozzle 26 and frozen confection 12 allows the product filler head assembly 25 of the machine 22 to quickly and accurately fill each additional set or row of product holders 14. Furthermore, as all of the individual nozzles 26 are connected by gears and motors, each of the nozzles will dispense and rotate the frozen confection 12 at the same rate. Therefore, the result is a consistent frozen confection product 10 being produced at each of the plurality of nozzles.

The foregoing description has been present for purposes of illustration and description, and is not intended to be exhaustive list or to limit the invention to precise forms disclosed. It is contemplated that other alternative processes obvious to those skilled in the art are considered to be included in the invention. The descriptions are merely examples of embodiments. For example, while it has been mentioned that the second secondary gear 44 is spun by the shaft 46, it is contemplated that the gear may be driven by motors both above and below the gear itself. Furthermore, the invention contemplates that, in an exemplary system of eight nozzles, two motors can be used such that each motor controls the rotation of four nozzles each. However, the exact number of nozzles, gears, motors, stations, and confections are not to limit the present invention, and any change obvious to one skilled in the art is contemplated to be a part of the present invention. In addition, as noted, the composition of the confection 12, second confection 18, third confection 20, and product holder 14 may be varied as desired to create different types of products 10. For example, the product holder may be different shapes, and may be either edible or inedible. In addition, the composition of the confections may vary as noted above as well.

It is understood that any other modifications, substitutions, and/or additions may be made, which are within the intended spirit and scope of the invention. What has been described is an improved method and apparatus for making a confection product, such as a frozen confection product. It will be understood that the use of the apparatus and method of the present invention will provide a more desired type of confection product.

What is claimed is:

1. A method of making a frozen confection product, comprising:
providing a plurality of frozen confection dispensing nozzles;
rotating the plurality of nozzles;
dispensing a frozen confection from the nozzles into a first plurality of product holders as the nozzles rotate; and
moving the nozzles to a second plurality of product holders to dispense a frozen confection therein;
wherein the plurality of nozzles continuously rotate and dispense the frozen confection during the step of moving from the first plurality of products holders to the second plurality of product holders.

2. The method of claim 1 further comprising repeating the steps to continuously move the nozzles to a next plurality of product holders to dispense a frozen confection therein.

3. The method of claim 2 wherein the plurality of nozzles continuously rotate and dispense frozen confection into the product holders as the method repeats the steps.

4. The method of claim 1 further comprising inserting a filling into the bottom of the product holder prior to dispensing a frozen confection therein.

5. The method of claim 1 further comprising dispensing a second confection from the nozzles into the plurality of product holders at the same time as dispensing the frozen confection therein.

6. The method of claim 5 wherein the nozzles comprise an inner tube for dispensing the second confection and an outer tube for dispensing the frozen confection.

7. The method of claim 1 wherein the nozzles are rotated by an electric motor.

8. The method of claim 1 wherein the plurality of nozzles each comprise a gear to aid in rotating the nozzles.

9. The method of claim 9 further comprising rotating at least one of the gears with an electric motor, wherein the gears of the nozzles will cause each of the plurality of nozzles to rotate at the same speed.

10. A method of making a frozen confection product, comprising:
providing a plurality of dispensing nozzles and a plurality of product holders;
rotating the dispensing nozzles while dispensing a frozen confection into a first set of the plurality of product holders;
moving the product holders relative to the dispensing nozzles to dispense the frozen confection into a second set of the plurality of product holders;
wherein the dispensing nozzles continuously rotate and dispense the frozen confection as the product holders are moved from the first set to the second set.

11. The method of claim 10 further comprising repeating the steps to dispense the frozen confection into additional sets of product holders.

12. The method of claim 11 wherein the dispensing nozzles continuously spin and dispense the frozen confection as the additional sets of product holders are moved relative to the nozzles.

13. The method of claim 10 further comprising moving the nozzles as the product holders are moved.

14. The method of claim 13 wherein the nozzles move generally in a vertical direction, while the product holders move generally in a horizontal direction.

15. The method of claim 13 wherein the nozzles move in both a vertical and a horizontal direction.

16. The method of claim 10 further comprising dispensing a second confection into the sets of product holders at the same time as dispensing the frozen confection into the product holders.

17. The method of claim 16 further comprising dispensing a third confection onto the frozen confection after the frozen confection and the second confection have been dispensed into the product holders.

18. An apparatus for making a frozen confection product, comprising:
a plurality of nozzles comprising a fixed insertion end for receiving a frozen confection and a rotatable dispensing end for dispensing the frozen confection;
a gear at the dispensing end and fixed thereto; and
a second gear operably connected to the first gear and adapted to continuously rotate the first gear and dispensing end of at least one of the nozzles while the nozzle dispenses a frozen confection.

19. The apparatus of claim 18 further comprising a secondary nozzle positioned at least partially within each of the nozzles and adapted to dispense a second confection.

20. The apparatus of claim 19 further comprising an electric motor operably connected to the second gear to continuously rotate the second gear and the at least one nozzle.
